(19) United States
(12) Patent Application Publication
(10) Pub. No.: US 2013/0111401 A1
(43) Pub. Date: May 2, 2013

(54) INTERVIEWEE EVALUATOR

(71) Applicants: Mark William Newman, Orem, UT (US); Grant Jay Gordon, Springville, UT (US); Peter Melvin Clegg, Orem, UT (US)

(72) Inventors: Mark William Newman, Orem, UT (US); Grant Jay Gordon, Springville, UT (US); Peter Melvin Clegg, Orem, UT (US)

(73) Assignee: HIREVUE, INC., Draper, UT (US)

(21) Appl. No.: 13/285,979

(22) Filed: Oct. 31, 2011

(51) Int. Cl. G06F 3/048

(52) U.S. Cl. 715/810

(57) ABSTRACT

A user interface for evaluating interview candidates. A user interface, including a first interview card is displayed. The first interview card includes information about a first interviewee and the first interviewee's response to a first interview question. User input indicative of a direction is received. The user input is either indicative of a direction in a first plane or indicative of a direction in a second plane. When the user input is in a direction in the first plane, a second interview card is displayed including information about a second interviewee and the second interviewee's response to the first question. When the user input is in a direction in the second plane, a third interview card is displayed including information about the first interviewee and the first interviewee's response to a second question.

### BACKGROUND

### Background and Relevant Art

Finding and hiring employees is a task that impacts most modern businesses. It is important for an employer to find employees that “fit” open positions. Criteria for fitting an open position may include skills necessary to perform job functions. Employers may also want to evaluate potential employees for mental and emotional stability, ability to work well with others, ability to assume leadership roles, ambition, attention to detail, problem solving, etc.

However, the processes associated with finding employees can be expensive and time consuming for an employer. Such processes can include evaluating resumes and cover letters, telephone interviews with candidates, in-person interviews with candidates, drug testing, skill testing, sending rejection letters, offer negotiation, training new employees, etc. A single employee candidate can be very costly in terms of man hours needed to evaluate and interact with the candidate before the candidate is hired.

Computers and computing systems can be used to automate some of these activities. For example, many businesses now have on-line recruiting tools that facilitate job postings, resume submissions, preliminary evaluations, etc. Additionally, some computing systems include functionality for allowing candidates to participate in “virtual” on-line interviews.

While computing tools have automated interview response gathering, There is still a lot of effort spent in evaluating responses. Often, respondents may be evaluated individually and ranked in the aggregate while side by side comparisons of specifics for different candidates may be difficult. For example, an evaluator, to compare specific answers of interviewees side by side, would need to search through stored responses for one candidate, access responses for another candidate, and search through the responses for the other candidate to find corresponding data needed for comparisons.

The job of interviewers and candidate reviewers is to determine if candidates are skilled and have the qualifications required for a particular job. In the process of doing this, they compare and contrast the qualifications of candidates—often reviewing and comparing candidate responses to particular questions or tasks. As noted, the comparison process is often difficult as interviews are reviewed linearly (from beginning to end) and comparing responses for each candidate to a specific question is tedious and requires reordering and cross comparing. The result is that responses are often not evaluated equally, fairly or in light of other candidate responses.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method practiced in a computing environment. The method includes acts for implementing a user interface for evaluating interview candidates. The method includes displaying a user interface, including displaying a first interview card. The first interview card includes information about a first interviewee and the first interviewee's response to a first interview question. The method further includes receiving user input indicative of a direction. The user input is either indicative of a direction in a first plane or indicative of a direction in a second plane. The first and second planes are substantially perpendicular to each other. When the user input is in a direction in the first plane, and as a result of the user input being in a direction in the first plane, the method further includes displaying a second interview card. The second interview card includes information about a second interviewee and the second interviewee's response to the first question. When the user input is in a direction in the second plane, and as a result of the user input being in a direction in the second plane, The method further includes displaying a third interview card. The third interview card includes information about the first interviewee and the first interviewee's response to a second question.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a graphical user interface for evaluating interview candidates; and

FIG. 2 illustrates a method of implementing a user interface for evaluating interview candidates.

### DETAILED DESCRIPTION

Some embodiments described herein implement digital sliding cards in horizontal and vertical directions to evaluate interviewees and interviewee responses. In some embodiments, all question responses for a single candidate are on digital cards aligned on a horizontal axis. In these embodiments, horizontal question decks are stacked vertically with each candidate and their responses being a separate row.

In the illustrated examples, a reviewer can rapidly navigate to any candidate or any question at any time. Reviewers can move horizontally (question to question) or vertically (candidate to candidate) at any time. Movement may be via mouse, touchpad or keyboard arrows for rapid movement. In one example, using a mouse or touchpad, users can navigate by clicking on horizontal or vertical arrows, clicking specific question numbers or candidate names, or by touch-sliding the digital cards in the X or Y direction.

This allows for the ability to rapidly move in the X or Y direction, comparing different candidate responses to the same question—or—comparing a single candidate's responses to different questions.

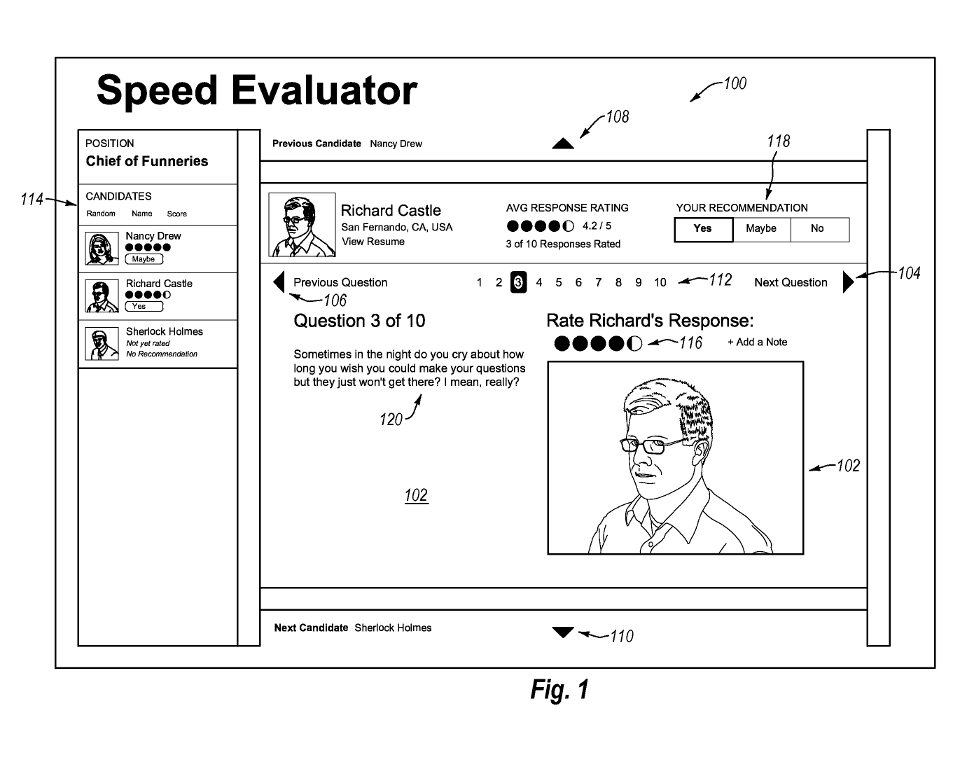

Referring now to FIG. 1, an example is illustrated. FIG. 1 illustrates a user interface 100 that may be displayed on a display of a computing system. The user interface allows interaction with digital sliding cards, such as card 102, in horizontal and vertical directions to evaluate interviewees and interviewee responses. In the illustrated embodiment, question responses for a single candidate are on digital cards aligned on a horizontal axis. Horizontal question decks are stacked vertically with each candidate and their responses being a separate row.

In the illustrated examples, a reviewer can rapidly navigate to candidates or questions. For example, a reviewers can move horizontally (question to question) or vertically (candidate to candidate). Movement may be via mouse, touchpad or keyboard arrows for rapid movement.

For example, using a mouse or touchpad, users can interact with the user interface 100. In some embodiments, users navigate by clicking on horizontal arrows, such as arrows 104 or 106 to navigate question to question or vertical arrows, such as arrows 108 or 110 to move from candidate to candidate.

Alternatively or additionally, user can click interface elements for specific question numbers or candidate names. For example, FIG. 1 illustrates a question selection interface element 112 that allows a user to select a specific question by question number. While question numbers only are illustrated in FIG. 1, it should be appreciated that in other embodiment a short summary of a question, a question title, a question type or other summary information may be included in the question selection interface element 112 with options selectable by a user.

Similarly FIG. 1 illustrates a candidate selection user interface element 114. The candidate selection user interface element 114 includes user selectable options that allow a user to quickly select a particular candidate. In the example illustrated, the candidate selection user interface element 114 includes items such as a candidate name, a candidate picture, a candidate rating, and hiring recommendations for each candidate.

These items may be affected by others who have previously reviewed a candidate's question cards and provided feedback about a candidate. For example, FIG. 1 illustrates a rating interface element 116. One or more users can interact with the rating interface element 116 to rate a particular candidate. Information from such interactions can be aggregated on a rating display shown in the candidate selection user interface element 114.

Similarly, the interface 100 includes a recommendation selection user interface element 118. Users can select various alternatives on this element 118 such as yes, no or maybe, indicating whether or not a candidate is recommended for hiring. The aggregated recommendation of various users can be summarized on the candidate selection user interface element 114.

Alternatively or additionally, user can move horizontally (question to question in the illustrated example) or vertically (candidate to candidate in the illustrated example) by touch-sliding the digital cards in the X or Y direction. For example, a user could touch their finger or a stylus onto a touch enabled screen displaying the user interface 100. The user could swipe left or right to change questions for a given candidate or swipe up and down to change candidates for a given question.

Embodiments may be used for various types of interview question responses. For example, embodiments may be used with video, audio, essay, short answer, multiple choice or other digital forms. For example, interview questions response may include images, documents, program code, diagrams, etc. FIG. 1 illustrates an example where a question 120 is illustrated, and the response is illustrated as a video clip 122. The response could be any other appropriate format including an audio clip, essay, true/false response, short answer, multiple choice response, image, document, solved mathematical or other problem, program code, drawing, diagram, etc.

Embodiments may include functionality for providing access to candidate profile information. Such information may include, for example, a resume, interview completed date, interview rating/score, etc. Such information may be available for each candidate during evaluation by a user.

Embodiments may include the ability to select final candidate recommendation option at any time during evaluation. For example, using the recommendation selection user interface element 118, a user can select a candidate recommendation option.

Embodiments may include the ability to set candidate or question scores at any time during evaluation. For example, FIG. 1 illustrates the rating interface element 116 that can be used to set a score for a candidates response to a particular question.

Embodiments may include the ability to add comments/notes about response or candidate at any time during the evaluation

Embodiments may be used on a number of different platforms. For example, embodiments may be implemented using a stand-alone application implemented on a computing device. For example an application may be written for a desktop environment, a smart phone environment, a tablet environment, etc. Alternatively or additionally, embodiments may be implemented using browser-based applications that run inside of a browser or other framework.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

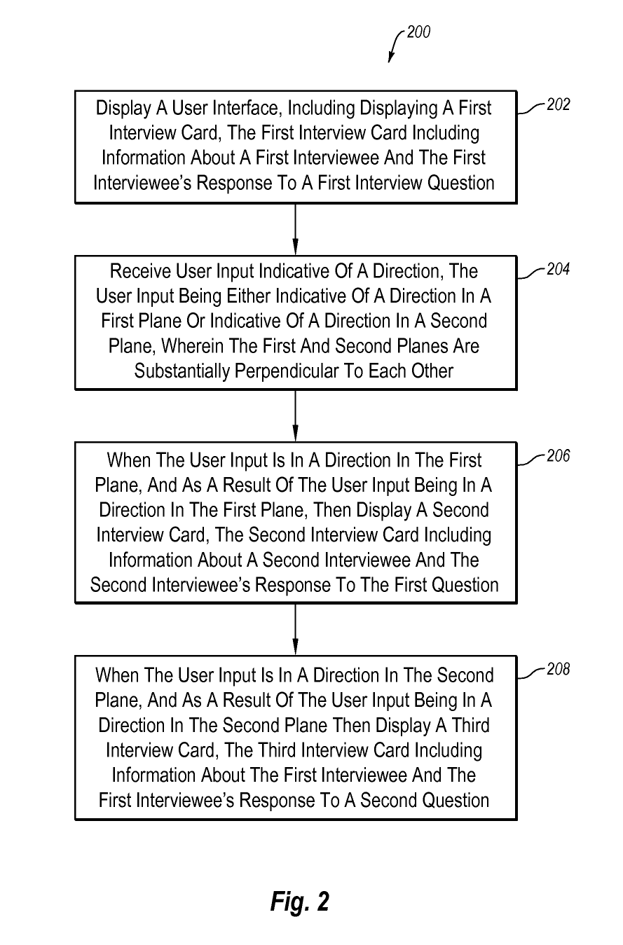

Referring now to FIG. 2, a method 200 is illustrated. The method 200 may be practiced in a computing environment. The method includes acts for implementing a user interface for evaluating interview candidates. The method includes displaying a user interface, including displaying a first interview card, the first interview card including information about a first interviewee and the first interviewee's response to a first interview question (act 202). For example. FIG. 1 illustrates a card 102 showing an interview candidate and question details.

The method 200 further includes receiving user input indicative of a direction, the user input being either indicative of a direction in a first plane or indicative of a direction in a second plane, wherein the first and second planes are substantially perpendicular to each other (act 202). User input indicating a direction will be discussed in more detail below. However, FIG. 1 illustrates substantially perpendicular planes with different questions being in a horizontal plane and different interviewees being in a vertical plane.

The method 200 further includes, when the user input is in a direction in the first plane, and as a result of the user input being in a direction in the first plane, then displaying a second interview card, the second interview card including information about a second interviewee and the second interviewee's response to the first question. In the illustrated example, detected user input in the vertical plane causes a card with a different interviewee's response to a same question as a first interviewee to be displayed. For example, user input in the upward direction will cause a card with “Sherlock Holmes” answer to question 3 to be displayed, whereas user input in a downward direction will cause a card with “Nancy Drew's” answer to question 3 to be displayed.

The method 200 further includes, when the user input is in a direction in the second plane, and as a result of the user input being in a direction in the second plane then displaying a third interview card, the third interview card including information about the first interviewee and the first interviewee's response to a second question. In the illustrated example, detected user input in the horizontal plane causes a card with a different answer to a different question for a same interviewee to be displayed. For example, in the illustrated example, detected user input to the right may cause a card with “Richard Castle's” answer to question 4 to be displayed. Detected user input to the left may cause a card with “Richard Castle's” answer to question 2 to be displayed.

Embodiments may be practiced where the user input indicative of a direction comprises a user selecting a graphically displayed element. For example, the graphically displayed element may be an arrow indicator, such as arrow indicators 104, 106, 108 or 110. Alternatively, the graphically displayed element may be an interviewee name. For example, FIG. 1 illustrates a candidate selection user interface element 114 where an interviewee name can be selected. A user can select an interviewee above or below a currently selected interviewee to indicate a direction.

Alternatively, the graphically displayed element may be a question number. For example, FIG. 1 illustrates a question selection interface element 112. A user can select a question number before or after the current question to indicate a direction.

Embodiments may be practiced where the user input indicative of a direction comprises a user selecting a hardware key. For example, a user may select an arrow key on a keyboard. Alternatively, a user may use mouse flicks, mouse buttons, scroll wheels, accelerometers tilting in a particular direction, motion sensors (such as cameras) to detect user movement, etc.

Embodiments may be practiced where the user input indicative of a direction comprises a user swiping a touch enabled user interface. For example, a user may contact a capacitive or resistive touch screen and swipe in a particular direction. For example, swiping to the right in FIG. 1 causes a card with “Richard Castle's” response to question 2 to be displayed while an upward swipe causes a card with “Sherlock Holmes” answer to question 3 to be displayed.

The method 200 may further include displaying summary information for other interview cards in a direction for the other interview cards without displaying the other interview cards. For example, FIG. 1 illustrates a previous candidate “Nancy Drew”, but other than her name, does not display other information. In contrast, for the displayed card 102, the name, location, a link to a resume, ratings, etc. are shown for “Richard Castle”, the current candidate in the current card. While not shown, similar summary information may be included for answers/questions on other cards.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of implementing a user interface for evaluating interview candidates, the method comprising:
displaying a user interface, including displaying a first interview card, the first interview card including information about a first interviewee and the first interviewee's response to a first interview question;
receiving user input indicative of a direction, the user input being either indicative of a direction in a first plane or indicative of a direction in a second plane, wherein the first and second planes are substantially perpendicular to each other;
when the user input is in a direction in the first plane, and as a result of the user input being in a direction in the first plane, then displaying a second interview card, the second interview card including information about a second interviewee and the second interviewee's response to the first question; and
when the user input is in a direction in the second plane, and as a result of the user input being in a direction in the second plane then displaying a third interview card, the third interview card including information about the first interviewee and the first interviewee's response to a second question.

2. The method of claim 1, wherein the user input being indicative of a direction comprises a user selecting a graphically displayed element.

3. The method of claim 2, wherein the graphically displayed element comprises an interviewee name.

4. The method of claim 2, wherein the graphically displayed element comprises a question number.

5. The method of claim 1, wherein the user input being indicative of a direction comprises a user selecting a hardware key.

6. The method of claim 1, wherein the user input being indicative of a direction comprises a user swiping a touch enabled user interface.

7. The method of claim 1, further comprising displaying summary information for other interview cards in a direction for the other interview cards without displaying the other interview cards.

8. A computer readable medium comprising computer executable instructions that when executed by one or more processors causes one or more processors to perform the following:
displaying a user interface, including displaying a first interview card, the first interview card including information about a first interviewee and the first interviewee's response to a first interview question;
receiving user input indicative of a direction, the user input being either indicative of a direction in a first plane or indicative of a direction in a second plane, wherein the first and second planes are substantially perpendicular to each other;
when the user input is in a direction in the first plane, and as a result of the user input being in a direction in the first plane, then displaying a second interview card, the second interview card including information about a second interviewee and the second interviewee's response to the first question; and
when the user input is in a direction in the second plane, and as a result of the user input being in a direction in the second plane then displaying a third interview card, the third interview card including information about the first interviewee and the first interviewee's response to a second question.

9. The computer readable medium of claim 8, wherein the user input being indicative of a direction comprises a user selecting a graphically displayed element.

10. The computer readable medium of claim 9, wherein the graphically displayed element comprises an interviewee name.

11. The computer readable medium of claim 9, wherein the graphically displayed element comprises a question number.

12. The computer readable medium of claim 8, wherein the user input being indicative of a direction comprises a user selecting a hardware key.

13. The computer readable medium of claim 8, wherein the user input being indicative of a direction comprises a user swiping a touch enabled user interface.

14. The computer readable medium of claim 8, further comprising displaying summary information for other interview cards in a direction for the other interview cards without displaying the other interview cards.

15. A computing system for implementing a user interface for evaluating interview candidates, the computing system comprising:
one or more processors;
one or more computer readable media coupled to the one or more processors, wherein the one or more computer readable media comprise computer executable instructions that when executed by one or more of the one or more processors cause one or more of the one or more processors to perform the following:
displaying a user interface, including displaying a first interview card, the first interview card including information about a first interviewee and the first interviewee's response to a first interview question;
receiving user input indicative of a direction, the user input being either indicative of a direction in a first plane or indicative of a direction in a second plane, wherein the first and second planes are substantially perpendicular to each other;
when the user input is in a direction in the first plane, and as a result of the user input being in a direction in the first plane, then displaying a second interview card, the second interview card including information about a second interviewee and the second interviewee's response to the first question; and
when the user input is in a direction in the second plane, and as a result of the user input being in a direction in the second plane then displaying a third interview card, the third interview card including information about the first interviewee and the first interviewee's response to a second question.

16. The computing system of claim 15, wherein the user input being indicative of a direction comprises a user selecting a graphically displayed element.

17. The computing system of claim 16, wherein the graphically displayed element comprises an interviewee name.

18. The computing system of claim 16, wherein the graphically displayed element comprises a question number.

19. The computing system of claim 15, wherein the user input being indicative of a direction comprises a user selecting a hardware key.

20. The computing system of claim 15, wherein the user input being indicative of a direction comprises a user swiping a touch enabled user interface.
